(19) United States
(12) Patent Application Publication
(10) Pub. No.: US 2020/0364007 A1
(43) Pub. Date: Nov. 19, 2020

(54) IMAGE FORMING DEVICE, CONTROL METHOD OF IMAGE FORMING DEVICE, AND PROGRAM

(71) Applicant: KONICA MINOLTA, INC., Tokyo (JP)

(72) Inventor: Tomoko YAMAMOTO, Tokyo (JP)

(73) Assignee: KONICA MINOLTA, INC., Tokyo (JP)

(21) Appl. No.: 16/838,298

(22) Filed: Apr. 2, 2020

(30) Foreign Application Priority Data
May 13, 2019 (JP) 2019-090475

(51) Int. Cl. G06F 3/12; H04N 1/00

(52) U.S. Cl. CPC G06F 3/1208; G06F 3/121; H04N 1/00724; H04N 1/00082; H04N 1/00037

(57) ABSTRACT

An image forming device includes: an image former that forms an image of original data included in a job on paper; a reader that reads the image formed on the paper; and a hardware processor, wherein the hardware processor performs control of determining whether the paper is paper on which the image of the original data is formed, control of allowing the image former to form an image for adjustment on the paper in a case where the paper is used for a purpose other than a purpose of forming the image of the original data, and control of allowing the reader to read the image for adjustment and adjusting the image former based on read data of the image for adjustment.

The entire disclosure of Japanese patent Application No. 2019-090475, filed on May 13, 2019, is incorporated herein by reference in its entirety.

### BACKGROUND

### Technological Field

The present invention relates to an image forming device, a control method of the image forming device, and a program.

### Description of the Related Art

As paper handled in an image forming device, there is paper that is not used by a user and is assumed to be discarded. Generally, normal paper is provided to the user as a product of a job in the job indicated by the user for the image forming device. In contrast, there is a case where some sheets of paper are not used for a purpose of the job indicated by the user and not provided to the user as the product.

Examples of such paper that is not used for a required purpose in the job indicated by the user include, for example, residual paper when an abnormality is detected in the image forming device, mark preventing paper for preventing an uneven shape on the paper in a stacker, a separator page inserted at the time of mass printing, surplus tab paper and the like.

Paper that is not used for the purpose required in the job is discarded without being used, so that this poses a problem in terms of cost and environment. Therefore, it is suggested to effectively use the paper that is not used for the purpose required in the job for other purposes. For example, suggested is an image forming device that enables effective use of residual paper when an abnormality is detected in the image forming device (for example, refer to JP 2014-119668 A). In this image forming device, it is determined whether an image is normal based on information of the image, and in a case where it is determined that there is image abnormality, the residual paper remaining in the device in a conveying state is conveyed by a paper conveyor. At the same time, an image pattern is formed in an image non-formed area on at least a part of the residual paper. Then, the image on the residual paper is detected by an image detector to obtain information of the image, and it is determined whether the image is normal based on the information of the image.

The image forming device disclosed in JP 2014-119668 A discloses that, in a case where paper on which an image of original data included in a job is formed in the job indicated by a user becomes residual paper when image quality abnormality is detected, this may be effectively used for adjusting an image of the image forming device. However, in the image forming device disclosed in JP 2014-119668 A, it is not disclosed to effectively use paper that is not used for a purpose required in the job other than the residual paper.

### SUMMARY

In order to solve the above-described problem, according to the present invention, provided are an image forming device, a control method of the image forming device, and a program capable of effectively using the paper that is not used for the purpose required in the job for image adjustment.

To achieve the abovementioned object, according to an aspect of the present invention, an image forming device reflecting one aspect of the present invention comprises: an image former that forms an image of original data included in a job on paper; a reader that reads the image formed on the paper; and a hardware processor, wherein the hardware processor performs control of determining whether the paper is paper on which the image of the original data is formed, control of allowing the image former to form an image for adjustment on the paper in a case where the paper is used for a purpose other than a purpose of forming the image of the original data, and control of allowing the reader to read the image for adjustment and adjusting the image former based on read data of the image for adjustment.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating a configuration of an image forming system;

FIG. 2 is a block diagram illustrating an example of an internal configuration of an image forming device;

FIG. 3 is a block diagram illustrating an example of an internal configuration of a controller;

FIG. 4 is a flowchart for adjusting the image forming device using other-purpose paper;

FIG. 5 is a view illustrating an example of a setting screen of an adjustment item using other-purpose paper; and

FIG. 6 is a view illustrating an example of a setting screen of an adjustment item using other-purpose paper.

### DETAILED DESCRIPTION OF EMBODIMENTS

Hereinafter, one or more embodiments of the present invention will be described with reference to the drawings. However, the scope of the invention is not limited to the disclosed embodiments.

[Configuration of Image Forming System]

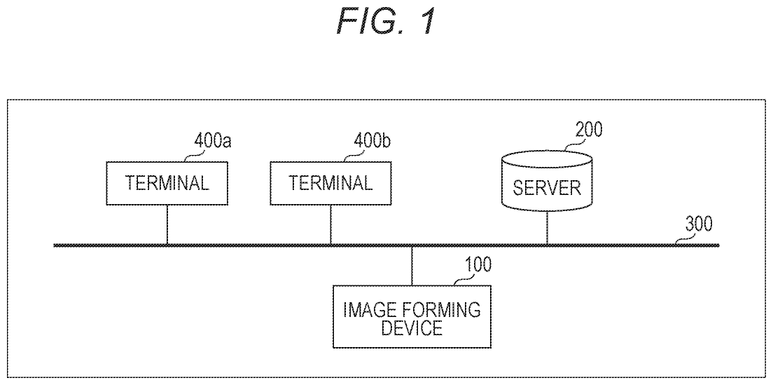

FIG. 1 illustrates a configuration of an image forming system including an image forming device of this embodiment.

The image forming system illustrated in FIG. 1 includes client terminals 400a and 400b capable of transmitting a print job, an image forming device 100, and a network server 200. The client terminals 400a and 400b, the image forming device 100, and the network server 200 are connected via a network 300 so as to be able to communicate with one another.

The image forming system of this embodiment includes the image forming device 100 that converts the print job into raster data, prints an image on paper using an image forming process, and performs in-line colorimetry on the printed image. The image forming device 100 is only required to have a function of forming the image, and may be, for example, a multi-functional peripheral (MFP).

The network 300 includes various networks such as a local area network (LAN) that connects computers and network devices according to standards such as Ethernet (registered trademark), Token Ring, and fiber-distributed data interface (FDDI), a wide area network (WAN) that connects the LANs by a dedicated line, the Internet, and a combination thereof. Note that, a type and the number of devices connected to the network 300 are not limited to those of the example illustrated in FIG. 1.

In the client terminals 400a and 400b, a built-in processor controls the above-described units and executes various arithmetic processes according to a program. For example, the client terminals 400a and 400b execute document data creation, a process of converting the document data and the like into a page description language (PDL), print job generation, print job transmission and the like. A printer driver for performing print setting and the like for the created original data is installed in the client terminals 400a and 400b. A user may select the original data for performing an image forming process and may specify the print setting (including setting of a post-process) for the original data via the printer driver. The selected original data is converted into PDL data described in the PDL that the image forming device 100 may interpret together with the print setting specified by the user. The PDL data converted and generated for each print instruction becomes the print job. Note that, examples of the PDL include, for example, PostScript (registered trademark) (PS), XML paper specification (XPS) and the like.

[Internal Configuration of Image Forming Device]

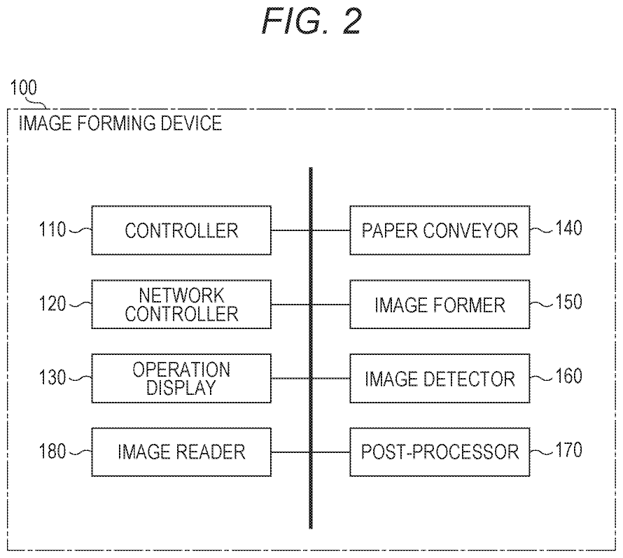

Next, a block diagram illustrating an example of an internal configuration of the image forming device 100 is illustrated in FIG. 2.

As illustrated in FIG. 2, the image forming device 100 includes a controller 110, a network controller 120, an operation display 130, a paper conveyor 140, an image former 150, an image detector 160, and a post-processor 170. They are connected via an internal bus so as to be able to communicate with one another.

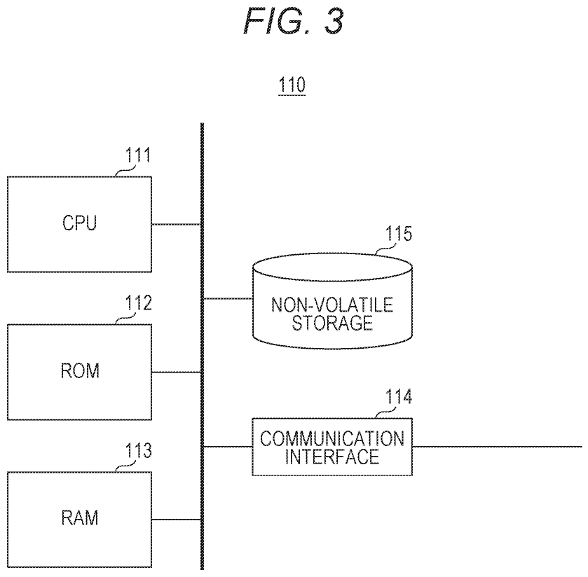

The controller 110 controls each unit of the image forming device 100. In the controller 110, a CPU 111 illustrated in FIG. 3 controls each unit of the image forming device and performs various arithmetic processes according to a program stored in a ROM 112. For example, the CPU 111 executes a rasterizing process (RIP process) of converting the original data included in the print job into the raster data. Each function of the image forming device 100 is exerted when the CPU 111 executes a corresponding program. The CPU 111 may be a multi-core processor so that a plurality of processes may be executed simultaneously.

The network controller 120 is an interface between blocks in the image forming device 100 for communicating with the image former 150 and the like.

The operation display 130 is provided with a display such as a liquid crystal display (LCD) and an organic electro luminescence display (ELD), a numeric keypad, a start button, a stop button, a touch panel arranged so as to be overlapped with the display and the like (the above are examples of an operator). The operation display 130 is used to input various settings by the user and to display various pieces of information.

The paper conveyor 140 conveys paper supplied from a paper feed tray to the image former 150, conveys the paper on which the image is formed by the image former 150 to the post-processor 170, and discharges the paper conveyed from the post-processor 170. Note that, the image forming device 100 may also be provided with a plurality of paper feed trays.

The image former 150 forms the image on the paper by using a well-known image forming process such as an electrophotographic process including steps of charging, exposing, developing, transferring, and fixing. The image former 150 forms the image based on the original data received via the network controller 120 and the original data received from the controller 110 via a communication interface 114 between the image forming devices 100.

The image detector 160 detects the image formed on the conveyed paper, and performs in-line measurement. For example, this performs colorimetry on the read image data by a spectral method (spectrophotometer) capable of measuring for each light wavelength, and outputs colorimetric values (L*a*b* value, XYZ value and the like). The image detector 160 may also be used as an image reader 180 for adjusting the image forming device 100.

The post-processor 170 executes the post-process on the paper on which the image is formed by the image former 150 based on the print setting included in the print job. The post-process executed by the post-processor 170 includes, for example, a stapling process of stapling a paper bundle, a punching process of punching a hole for filing at an end of the paper, a case binding process of bundling the paper to form into a shape of a book, a folding process of folding the paper, a trimming process of cutting the end of the paper and the like.

The image reader 180 is arranged downstream of the image former 150 in a paper conveyance direction. The image reader 180 is formed of, for example, an in-line sensor in which a plurality of detecting elements is arranged in a direction orthogonal to the paper conveyance direction (width direction), and reads the image formed on the paper by the image former 150.

[Internal Configuration of Controller]

FIG. 3 is a block diagram illustrating an internal configuration of the controller 110. The controller 110 is formed of the CPU 111, the ROM 112, a RAM 113, a non-volatile storage 115, and the communication interface 114. The controller 110 is used as an example of a computer that controls operation of each unit in the image forming device 100.

The CPU 111 performs a control process and an arithmetic process according to, for example, input operation of the user performed via the operation display 130. The CPU 111 reads to execute a program code of software that realizes each function according to this embodiment from the ROM 112 (an example of a recording material). Note that, in place of the CPU 111, another arithmetic device such as a micro processing unit (MPU) may also be used.

The ROM 112 is used as an example of a non-volatile memory, and stores a program, data and the like necessary for the CPU 111 to operate.

The RAM 113 is used as an example of a volatile memory, and serves as a work area that temporarily stores information (data) necessary for each process performed by the CPU 111.

The non-volatile storage 115 is an example of a recording material, and stores a program for the CPU 111 to control each unit, a program such as an OS, and data. For example, in the non-volatile storage 115, a recorder records data capacity after the RIP and the like in addition to a type, the number, resolution, data capacity, and a font type of an object regarding the original data.

As the non-volatile storage 115, for example, an HDD, a solid state drive (SSD), an optical disk, a magneto-optical disk, a CD-ROM, a CD-R, a magnetic tape, a non-volatile memory card and the like are used.

The communication interface 114 is formed of, for example, a network interface card (NIC), a modem and the like, establishes connection with a communication partner device via a network N such as the LAN, and executes transmission/reception of various data. The communication interface 114 is an interface for communicating with external devices on the network 300, and is provided with a receiver that receives the print job from the client terminals 400a and 400b and a receiver that receives various data in the server from the network server 200. As the network controller 120, a network interface according to standards such as Ethernet (registered trademark), Token Ring, and FDDI, a serial interface such as USB and IEEE 1394, a parallel interface such as SCSI and IEEE 1284, a wireless communication interface such as Bluetooth (registered trademark), IEEE 802.11, HomeRF, IrDA and the like may be used.

Note that, in the image forming system illustrated in FIG. 1 also, the terminals 400a and 400b have functions of the controller 110, the network controller 120, the operator, and the display described above.

[Flowchart of Image Formation]

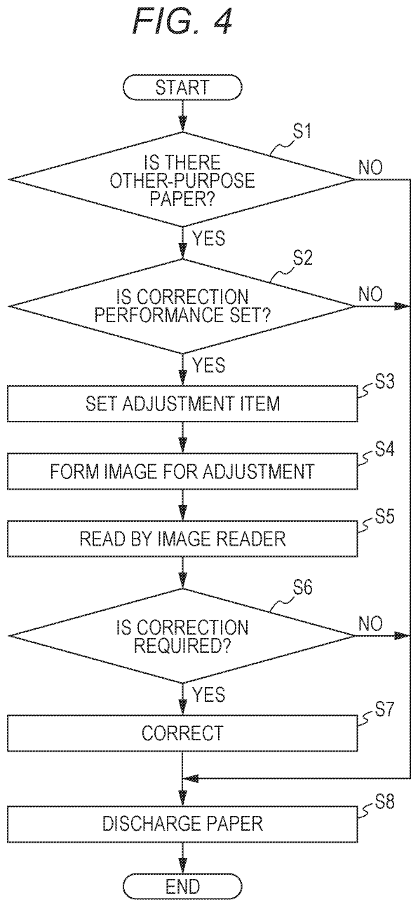

A procedure of adjusting the image forming device 100 in this embodiment is described with reference to a flowchart in FIG. 4.

The controller 110 determines whether, in the job indicated by the user for the image forming device 100 via the terminals 400a and 400b, the image of the original data included in the job is formed, the image of the original data included in the job indicated by the user is not formed on paper other than the paper provided to the user as the product of the job (product paper), and paper for other purposes not provided to the user as the product (other-purpose paper) is present (step S1).

In a case where there is the other-purpose paper in the job (YES at step S1), the controller 110 determines whether to correct the image forming device 100 using the other-purpose paper according to condition setting for each adjustment item registered in advance (step S2). In a case of correcting (YES at step S2), the controller 110 sets the adjustment item to be performed in the image forming device 100 according to a priority order registered in advance (step S3).

(Setting Example of Adjustment Item)

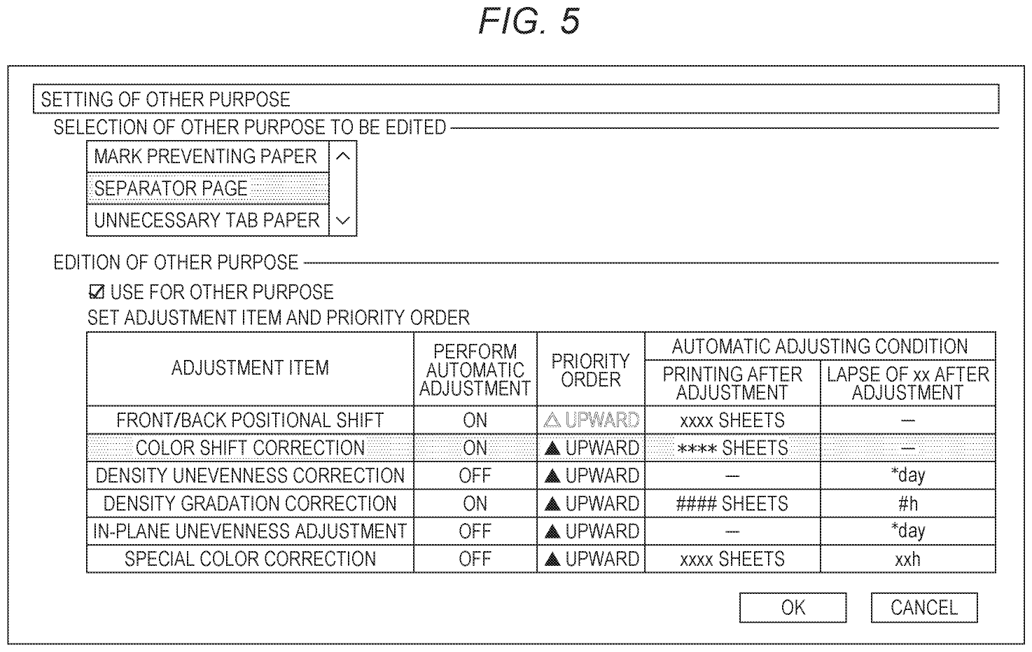

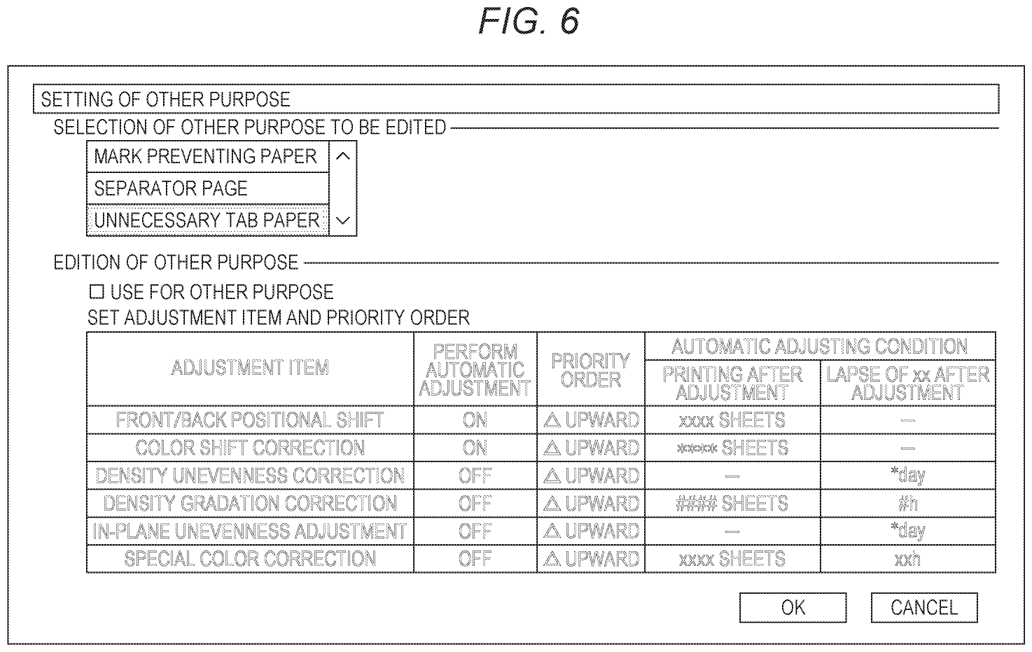

Hereinafter, a setting example of the adjustment item of the image forming device 100 using the other-purpose paper performed at steps S2 and S3 is described. FIGS. 5 and 6 illustrate examples of a setting screen of the adjustment item using the other-purpose paper.

As illustrated in FIG. 5, in the setting of adjusting the image forming device 100 using the other-purpose paper, the other-purpose paper is selected (other purpose to be edited is selected). In FIG. 5, “mark preventing paper”, “separator page”, and “unnecessary tab paper” are illustrated as the other-purpose paper. FIG. 5 illustrates a state in which the “separator page” is selected as the other-purpose paper to be edited.

Note that, the “mark preventing paper”, the “separator page”, and the “unnecessary tab paper” are types of paper used for the following purposes.

Mark preventing paper: There is a large-capacity stacker provided with a first tray that continuously discharges paper and a second tray that takes out the loaded paper, the stacker in which a large amount of paper after the image formation may be loaded having an uneven shape in a lowermost part of the second tray. When a large amount of thin paper is loaded in the second tray and left for a long time, a mark is formed on the paper due to an edge of an uneven portion. In the image forming device having a mark preventing paper mode in order to prevent this in which paper assumed to be discharged is discharged to the second tray as an underlay, it is set whether to use the mark preventing paper as the underlay is used for other purposes, and the purpose and the priority order in a case where this is used for other purposes are set.

Separator page: In the image forming device, there is a case of inserting blank paper in order to make separation of a predetermined unit of output paper clear, for example, for making the separation in the job clear in a case of stacking the job including a plurality of parts, thereby making a boundary clear. It is set whether to use the blank paper inserted as the separator for other purposes, and the purpose and priority order in a case where this is used for other purposes are set.

Unnecessary tab paper: In the image forming device that inserts tab paper for separation between sheets of paper on which the image is formed based on insertion information of the tab paper, in a case where the number of separations is smaller than the number of stocks of the tab paper, there is a case where unnecessary tab paper is discharged (for example, in a case where three sheets of the tab paper (five sheets make one set) are used as the separators, the remaining two sheets are discharged). It is set whether to use the discharged tab paper for other purposes, and the purpose and priority order in a case where this is used for other purposes are set.

In the setting example of the adjustment item illustrated in FIG. 5, for the selected other-purpose paper, it is set whether to use the same for other purposes, and the adjustment item and an executing condition of each adjustment item are set. In FIG. 5, since the item of the setting of whether to use the same for other purposes is checked, it is set to use the same for other purposes. In FIG. 5, as examples of the adjustment item, “front/back positional shift”, “color shift correction”, “density unevenness correction”, “density gradation correction”, “in-plane unevenness adjustment”, and “special color correction” are displayed.

In the executing condition of each adjustment item using the other-purpose paper, as for the setting of whether to automatically perform corresponding adjustment, it is illustrated “ON” in a case where the automatic adjustment is performed, and “OFF” in a case where the automatic adjustment is not performed. Furthermore, for the adjustment item to be automatically adjusted, a condition of performing the automatic adjustment is set. In FIG. 5, “printing after adjustment” and “lapse of xx after adjustment” are displayed as the conditions of performing the automatic adjustment. Under the condition of “printing after adjustment”, after printing a predetermined number of sheets of paper (displayed as “xxx sheets” and the like in FIG. 5), an image for adjustment is formed using the other-purpose paper, and the automatic adjustment of each item is performed using the image for adjustment. Under the condition of “lapse of xx after adjustment”, after a lapse of a predetermined time from the previous adjustment (displayed as “*day”, “#h” and the like in FIG. 5), the image for adjustment using the other-purpose paper is formed, and the automatic adjustment of each item using the image for adjustment is performed.

The priority order of the adjustment items indicates the priority order of determination of execution of each adjustment item based on the condition of performing the automatic adjustment described above. In FIG. 5, the determination of execution is sequentially performed while giving priority to the item displayed on an upper side of the screen, and the determination of execution of a lower-priority item is performed in a case where a higher-priority item is not executed.

The screen illustrated in FIG. 6 illustrates a state in which “unnecessary tab paper” is selected as selection of the other-purpose paper (selection of other purpose to be edited). In the screen illustrated in FIG. 6, since the item of the setting whether to use for other purposes is not checked, the condition is set such that the adjustment of the image forming device 100 using the other-purpose paper is not performed as the “unnecessary tab paper”. Therefore, the adjustment item and the setting of the executing condition of each adjustment item are grayed out such that they cannot be operated.

The flowchart illustrated in FIG. 4 is described again.

After setting the adjustment item using the other-purpose paper, the controller 110 performs control of forming the image for adjustment for correction in accordance with the set adjustment item on the other-purpose paper by the image former 150 (step S4). Next, the image reader 180 reads the image for adjustment formed on the other-purpose paper, and the controller 110 obtains read data of the image for adjustment (step S5).

Next, the controller 110 determines whether the correction of the adjustment item set in the image forming device 100 is necessary based on the obtained read data of the image for adjustment (step S6). For example, in a case where the controller 110 determines that the correction is necessary because an image quality does not satisfy a criterion (Yes at step S6), this corrects an image forming condition of the image former 150 of the image forming device 100 based on the read data of the image for adjustment (step S7).

After correcting the image forming condition of the image forming device 100, the image forming device 100 discharges the paper provided to the user as the product of the job (product paper) (step S8). In a case where it is determined that the correction is unnecessary (No at step S6), the controller 110 performs a process indicated by the job such as the image formation based on the original data without correcting the image forming condition of the image forming device 100, and discharges the paper provided to the user as the product of the job (product paper) (step S8). Furthermore, in a case where there is no other-purpose paper in the job (NO at step S1), and in a case where the image forming condition of the image forming device 100 is not corrected (NO at step S2), the image former 150 of the image forming device 100 performs the process indicated by the job such as the image formation based on the original data, and discharges the paper provided to the user as the product of the job (product paper) (step S8).

After the controller 110 drives the paper conveyor 140 to discharge the other-purpose paper on which the image for correction is printed from the image forming device 100, the procedure according to this flowchart ends.

According to the above-described method, it becomes possible to effectively use the paper for other purposes (other-purpose paper) that is not used for the image formation of the original data included in the job indicated by the user and is not provided to the user as the product for the image adjustment of the image forming device 100. Therefore, it is possible to effectively utilize the paper that is conventionally discarded, and there is no need to use normal paper for the image adjustment of the image forming device 100, so that this is effective in terms of cost and environment.

Although embodiments of the present invention have been described and illustrated in detail, the disclosed embodiments are made for purposes of illustration and example only and not limitation, and various modifications and changes may be made without departing from the configuration of the present invention. The scope of the present invention should be interpreted by terms of the appended claims.

What is claimed is:

1. An image forming device comprising:
an image former that forms an image of original data included in a job on paper;
a reader that reads the image formed on the paper; and
a hardware processor, wherein
the hardware processor performs
control of determining whether the paper is paper on which the image of the original data is formed,
control of allowing the image former to form an image for adjustment on the paper in a case where the paper is used for a purpose other than a purpose of forming the image of the original data, and
control of allowing the reader to read the image for adjustment and adjusting the image former based on read data of the image for adjustment.

2. The image forming device according to claim 1, wherein
the paper used for the other purpose is paper laid under the paper on which the image of the original data is formed.

3. The image forming device according to claim 1, wherein
the paper used for the other purpose is paper for separating the paper on which the image of the original data is formed by a predetermined unit.

4. The image forming device according to claim 1, wherein
the paper used for the other purpose is tab paper remaining in a paper feed tray without being used in a tab mixed job.

5. A control method of an image forming device provided with an image former that forms an image of original data included in a job on paper, a reader that reads the image formed on the paper, and a hardware processor, the control method comprising:
determining whether the paper is paper on which the image of the original data is formed;
allowing the image former to form an image for adjustment on the paper in a case where the paper is used for a purpose other than a purpose of forming the image of the original data; and
allowing the reader to read the image for adjustment and adjusting the image former based on read data of the image for adjustment.

6. A non-transitory recording medium storing a computer readable program for allowing a computer to execute:
determining whether paper is paper on which an image of original data included in a job indicated by a user is formed;
forming an image for adjustment on the paper in a case where the paper is used for a purpose other than a purpose of forming the image of the original data; and
reading the image for adjustment and adjusting an image former based on read data of the image for adjustment.
